(19) United States
(12) Patent Application Publication
(10) Pub. No.: US 2026/0008441 A1
(43) Pub. Date: Jan. 8, 2026

(54) FORCE DIAGNOSTIC FOR FORCE-SENSOR-LESS ELECTROMECHANICAL BRAKE SYSTEMS

(71) Applicant: HL MANDO CORPORATION, Gyeonggi-do (KR)

(72) Inventor: Jeremy DOBBS, Auburn, MI (US)

(21) Appl. No.: 19/220,938

(22) Filed: May 28, 2025

Related U.S. Application Data
(60) Provisional application No. 63/667,111, filed on Jul. 2, 2024.

(51) Int. Cl. B60T 8/171; B60T 1/06; B60T 8/172; B60T 13/74; F16D 66/00; F16D 66/02

(52) U.S. Cl. CPC B60T 8/171; B60T 8/172; B60T 13/746; F16D 66/00; B60T 1/065; B60T 2270/402; B60T 2270/406; F16D 2066/001; F16D 2066/003; F16D 2066/005; F16D 2066/006; F16D 66/02

(57) ABSTRACT

An electromechanical brake (EMB) system is provided. The EMB system includes: a brake rotor configured to be rotatable with a wheel of a vehicle; a brake pad assembly configured to be engageable with the brake rotor; an actuator assembly including an electric motor configured to mechanically move the brake pad assembly toward or away from the brake rotor; and an electronic control unit (ECU) including a processor associated with a memory that stores instructions that when executed by the processor causes the ECU to perform operations. The operations include: obtaining a primary path force estimate, a diagnostic path force estimate, and a force command; determining whether the EMB system has failed using the primary path force estimate, the diagnostic path force estimate, and the force command; and generating a force fault flag and initiating brake safety protocol processes in response to failure of the EMB system.

### CROSS REFERENCE TO PARENT APPLICATIONS

This application claims the benefit of U.S. Patent Application Ser. No. 63/667,111 filed on Jul. 2, 2024, entitled “FORCE ESTIMATION DIAGNOSTIC STRATEGY”, the entirety of which is incorporated herein by reference.

### BACKGROUND

Various embodiments of the present disclosure generally relate to an electromechanical brake (EMB) system (also referred to herein as an “EMB assembly”) and more particularly to a system and method for thermal management of the EMB system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) system may comprise: a brake rotor configured to be rotatable with a wheel of a vehicle; a brake pad assembly configured to be engageable with the brake rotor; an actuator assembly comprising an electric motor configured to mechanically move the brake pad assembly toward or away from the brake rotor; and an electronic control unit (ECU) comprising a processor associated with a memory that stores instructions that when executed by the processor causes the ECU to perform operations comprising: obtaining a primary path force estimate, a diagnostic path force estimate, and a force command; determining whether the EMB system has failed using the primary path force estimate, the diagnostic path force estimate, and the force command; and generating a force fault flag and initiating one or more brake safety protocol processes in response to failure of the EMB system, wherein the EMB system is a force-sensor-less EMB system that is configured without any force sensors.

The primary path force estimate is obtained using a motor torque and a motor position of the electric motor.

The diagnostic path force estimate is obtained using at least one of a motor temperature or a motor linear position of the electric motor.

The motor torque, the motor position, the motor temperature, and the motor linear position of the electric motor are obtained by the ECU using one or more sensors installed within the EMB system.

The diagnostic path force estimate is obtained further using a pad wear of brake pads making up the brake pad assembly.

The determining of whether the EMB system has failed comprises determining whether the EMB system is unable to produce a required amount of braking force during a braking operation of the vehicle.

The determining of whether the EMB system has failed using the primary path force estimate, the diagnostic path force estimate, and the force command comprises: incrementing a force error counter each time the ECU determines, using the primary path force estimate, the diagnostic path force estimate, and the force command, that the EMB system is unable to produce the required amount of the braking force during the braking operation of the vehicle; and determining, in response to the force error counter exceeding a predetermined threshold, that the EMB system has failed.

The force command is obtained from a central controller of the vehicle that is separate and independent from the ECU, the force command specifying a type of braking operation to be implemented by the EMB system and an amount of braking force to be generated by the EMB system.

The initiating of one or more brake safety protocol processes comprises causing the EMB system to transition to a safe mode and notifying a central controller of the vehicle of the transition, the central controller being separate and independent from the ECU.

The primary path force estimate, the diagnostic path force estimate, and the force command are obtained by the ECU during a braking operation of the vehicle.

According to some embodiments of the present disclosure, a method for force diagnostics in a force-sensor-less EMB system is provided. The method is executed by an electronic control unit (ECU) of the force-sensor-less EMB system and comprises: obtaining a primary path force estimate, a diagnostic path force estimate, and a force command; determining whether the EMB system has failed using the primary path force estimate, the diagnostic path force estimate, and the force command; and generating a force fault flag and initiating one or more brake safety protocol processes, wherein the EMB system is a force-sensor-less EMB system that is configured without any force sensors, and wherein the EMB system comprises a brake rotor configured to be rotatable with a wheel of a vehicle on which the EMB system is installed, a brake pad assembly configured to be engageable with the brake rotor, and an actuator assembly comprising an electric motor configured to mechanically move the brake pad assembly toward or away from the brake rotor.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2 shows a data flow diagram illustrating a method for force diagnostics in a force-sensor-less brake assembly according to one or more exemplary embodiments of the present disclosure.

FIG. 3 shows a flow chart for illustrating a method for force diagnostics in a force-sensor-less brake assembly according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

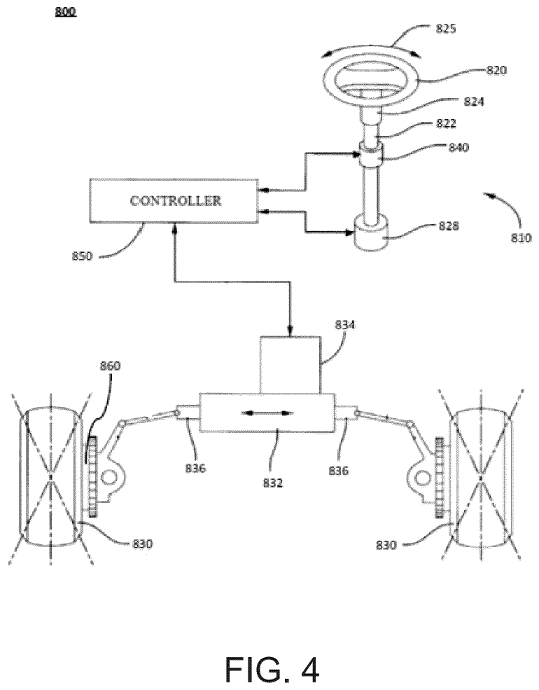

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Due to their mechanical nature and compact structure, such brake systems may not always have space for one or more sensors (e.g., force sensors) that are vital for safe and optimal operation of these brake systems. Installation of such a force sensor may also unnecessarily and/or significantly increase the overall costs of the brake systems. However, a method for determining (e.g., diagnosis) whether the brake systems are applying an adequate amount of force on a brake rotor to stop the rotation of the wheels of the vehicles is needed without having to rely on an actual sensor for measuring the force.

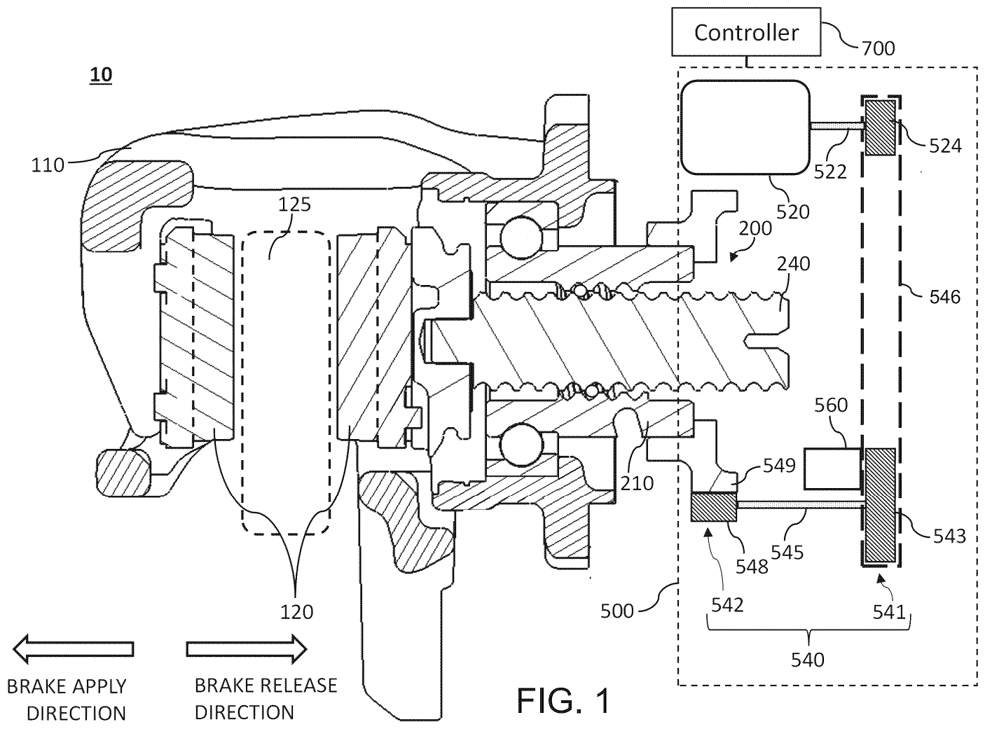

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatably part 210. Alternatively, the electric motor 520 is indirectly connected to the rotatably part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125).

These one or more sensors may include any type and combination of sensors including, but not limited to: (i) motor position sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from). In embodiments, the brake assembly 10 is not configured to include any sensors (e.g., force sensors) for measuring a clamp force (e.g., in Newtons) that is generated when the brake pad assembly 120 clamps onto (e.g., engages against) the brake rotor 125 to stope a rotation of the brake rotor 125 during braking operations of the vehicle. Essentially, in embodiments disclosed herein, the brake assembly 10 is a force-sensor-less brake assembly 10.

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

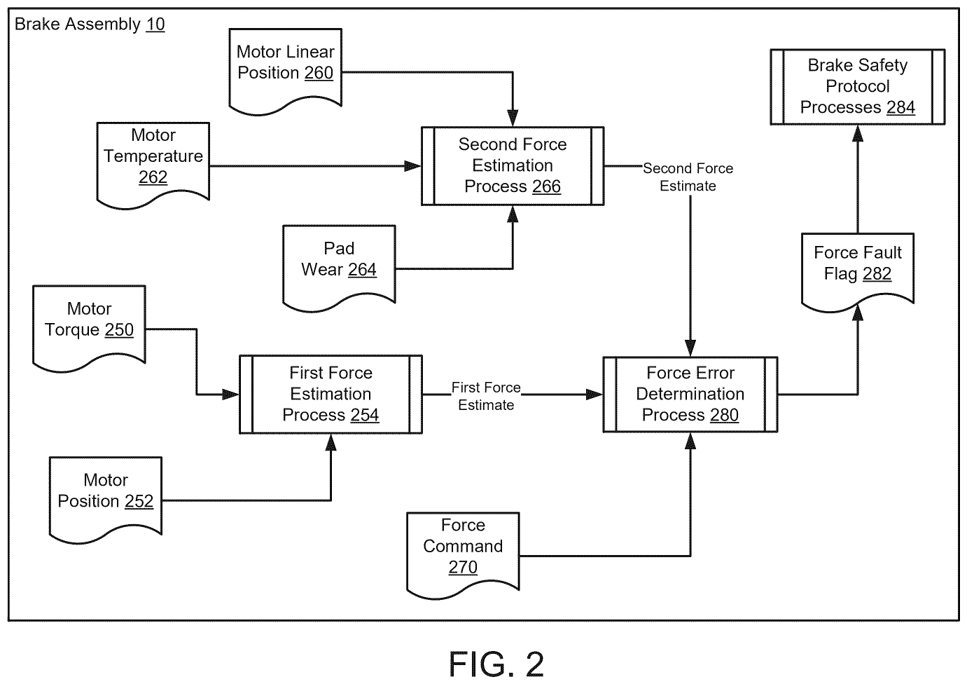

Turning now to FIG. 2, FIG. 2 shows a data flow diagram illustrating a method for force diagnostics in a force-sensor-less brake assembly according to one or more exemplary embodiments of the present disclosure.

In this diagram, flows of data and processing of data are illustrated using different sets of shapes. A first set of shapes (e.g., 250, 252, 260, 262, 282, etc.) is used to represent data structures (e.g., files, documents, data packets, or the like), a second set of shapes (e.g., 266, 254, 280, 284 etc.) is used to represent processes performed using and/or that generate data, and a third set of shapes (e.g., 10) is used to represent physical components that perform the processes depicted suing the second set of shapes. The data flow diagram of FIG. 2 may be performed by any of the computing-related/computing-enabled components (namely, controller 700 of brake assembly 10) shown in FIG. 1.

As shown in FIG. 2, motor torque 250 and motor position 252 may be obtained by the controller 700 of brake assembly 10. In embodiments, motor torque 250 may be the torque generated by electric motor 520 and motor position 252 may be a value that describes a physical position (e.g., a motor angle or the like) of the electric motor 520.

In embodiments, motor torque 250 and motor position 252 may be directly obtained (e.g., measured, sensed, detected, etc.) using the one or more sensors discussed above in reference to FIG. 1 (e.g., by a torque sensor and an absolute motor angle sensor installed within the brake assembly 10, or the like). Without departing from the scope of embodiments disclosed herein, motor torque 250 and motor position 252 may also be calculated using other values and properties of the brake assembly 10 that are obtained using any combination of sensors installed in brake assembly 10.

Upon obtaining the motor torque 250 and motor position 252 of electric motor 520, controller 700 may ingest the motor torque 250 and motor position 252 into first force estimation process 254 where the motor torque 250 and motor position 252 are used to obtain (e.g., calculate) a first force estimate. The first force estimate may represent an estimation of the clamp force being generated from the engagement of brake pad assembly 120 on brake rotor 125 during a braking operation of the vehicle. In embodiments, the first force estimation may be referred to herein as a “primary path force estimate”.

In embodiments, as part of first force estimation process 254, a predetermined force calculation model (e.g., mathematical model) may be used to convert the motor torque 250 and motor position 252 into the first force estimate. The predetermined force calculation model may be defined and preset into the controller 700 by a manufacturer of the brake assembly 10 and/or of the vehicle on which the brake assembly 10 is to be installed.

In embodiments and as further shown in FIG. 2, the controller 700 may further obtain a motor linear position 260, a motor temperature 262, and a pad wear 264. The motor linear position 260 may represent a linear position of the translatable part 240 actuated by the electric motor 520 relative to the brake rotor 125. More specifically the linear position may represent a how far away the brake pad (of the brake pad assembly 120) attached to the translatable part 240 is from the brake rotor 125.

The motor temperature 262 may represent a temperature (e.g., operating temperature) of the electric motor 520 (namely, at the time of the braking operation of the vehicle). The pad wear 264 may represent an amount of wear and tear of each of the brake pads of the brake pad assembly 120.

Each of the motor linear position 260, the motor temperature 262, and the pad wear 264 may be obtained (directly or indirectly) using one or more measurements from one or more of the sensors installed within the brake assembly 10. For example, the motor temperature 262 may be measured directly using a temperature sensor, or the like. The motor linear position 260 may be measured using a linear sensor or may be calculated and/or estimated using the motor position 252 in combination with a pad contact detection by the controller 700. Similarly, the pad wear 264 may also be directly measured and/or indirectly obtained (e.g., through calculation and/or estimation) using one or more other measured values and/or properties of the brake assembly 10.

Upon obtaining the motor linear position 260, motor temperature 262, and the pad wear 264, controller 700 may ingest these values into second force estimation process 266 where these values are used to obtain (e.g., calculate, estimate, or the like) a second force estimate. The second force estimate may represent another estimation (e.g., separate from the first force estimate) of the clamp force being generated from the engagement of brake pad assembly 120 on brake rotor 125 during the braking operation of the vehicle. In embodiments, the second force estimate may be referred to herein as a “diagnostic path force estimate”.

In embodiments, as part of second force estimation process 266, one or more look up tables or the like may be used to obtain the second force estimate using the motor linear position 260, motor temperature 262, and the pad wear 264. The one or more look up tables may be generated (e.g., created) and stored into the controller 700 by a manufacturer of the brake assembly 10 and/or of the vehicle on which the brake assembly 10 is to be installed.

As yet further shown in FIG. 2, the controller 700 may obtain force command 270. Force command 270 may be obtained by controller 700 from a main controller (e.g., 850 of FIG. 4) of the vehicle that controls all of the operations of the vehicle. The main controller may also be referred to herein as a “central controller of the vehicle”. More specifically, upon the driver (e.g., a human driver or a non-human driver such as an autonomous or semi-autonomous driving program) initiating a braking action the main controller may receive the driver's intention to brake and transmit this intention to brake as one or more braking commands to the controller 700 of the brake assembly 10 (namely, to all brake assemblies 10 installed on the vehicle).

In embodiments the braking commands from the central controller may include a braking force value (i.e., a clamp force value) required for achieving the type of braking (e.g., full stop, partial braking, hard stop, a rolling brake, or the like) desired by the driver. Such braking force value may be included as part of (e.g., specified in) force command 270, which is provided to controller 700 for controller 700 to control the parts of the brake assembly 10 to generate the braking force value specified.

In embodiments, the controller 700 may obtain all three of the force command 270, the primary path force estimation, and the diagnostic path force estimation every time a braking operation is required (e.g., performed by a driver of the vehicle).

Upon obtaining all three of the force command 270, the primary path force estimation, and the diagnostic path force estimation during a braking operation, the controller 700 may ingest these three force values into force error determination process 280.

As part of force error determination process 280, the controller 700 may perform one or more prestored calculations (e.g., ingest all or some of the force command 270, the primary path force estimation, and the diagnostic path force estimation into one or more prestored models, calculation, and/or algorithms) to determine whether a force fault has occurred during the braking operation.

In embodiments, a force fault may occur when the amount of clamping force generated between the brake pad assembly 120 and the brake rotor 125 deviates from an expected value or range and/or from an optimal (e.g., safe) clamping force value or range. In embodiments, this expected and/or optimal clamping force value or range may be (or may be based on) the braking force value specified in the force command. Alternatively, this expected and/or optimal clamping force value may be stored as one or more thresholds within the controller 700. Each of the force command 270, the primary path force estimation, and the diagnostic path force estimation (and/or deviations (e.g., deltas) between any of these three force values) may be compared to the prestored expected and/or optimal clamping force value to determine whether the braking assembly 10 is operating in an expected and safe manner during a braking operation.

Additionally, in embodiments, the expected and/or optimal clamping force value may be based on the type of braking operation being executed by the driver. Information regarding the type of braking operation being executed by the driver may be specified in the force command 270 obtained by the controller 700 and ingested into force error determination process 280.

In one or more embodiments, the force error determination process 280 may include a force error counter and the force fault flag 282 may only be generated by the controller 700 when the force error counter is incremented past (e.g., exceeds) a predetermined value. For example, each time the controller 700 determines (e.g., the force command 270, the primary path force estimation, and the diagnostic path force) that a force error has occurred, the force error counter will be incremented by one. Similarly, when the controller determines that no force error has occurred, the force error counter will be decreased by one. In this example, the force error counter may be incremented or reduced (e.g., decreased) only once during each instance of a braking operation of the vehicle.

In the event that the controller 700 determines (e.g., during force error determination process 280) that the braking assembly is not operating in an expected and safe manner during a braking operation, the controller 700 may generate force fault flag 282. For example, if the braking operation requires at least 5 Newtons of clamp force to be generated between the brake pad assembly 120 and the brake rotor 125 and the brake assembly 10 is only able to generate 2 Newtons, then controller 700 will assume that something may be wrong with the brake assembly 10 (e.g., one or more components of the brake assembly 10 may be broken, the pad wear 264 is at an amount that effective braking is no longer possible by the brake assembly 10 during one or more types of the braking operations, or the like).

Upon generating force fault flag 282, controller 700 may use force fault flag 282 in one or more brake safety protocol processes 284. For example, in some embodiments, the controller 700 may (upon obtaining force fault flag) cause the brake assembly 10 to enter a safety mode where the brake pad assembly 120 is locked in an open (non-engageable) position relative to the brake rotor 125. The controller 700 may then inform the central controller of the vehicle of such action of transitioning the brake assembly 10 into the safety mode such that the driver of the vehicle is made aware that at least one brake assembly 10 of the vehicle is no longer operational (and/or functional).

Alternatively, the controller 700 may just forward the force fault flag 282 directly to the central controller such and let the driver make a manual determine whether to switch the brake assembly 10 into the safety mode (based on other operating conditions of the vehicle as reported to the driver by the central controller). Other vehicle safety protocols may also be implemented (e.g., as part of brake safety protocol processes 284 of the brake assembly 10) to account for one (or more) of the brake assemblies 10 of the vehicle failing or inferred (e.g., estimated, assumed, or the like) to have failed. For example, another action that could be taken by brake assembly 10 is to cut power to the electric motor 520 from controller 700 such that the electric motor 520 is no longer able to cause the translatable part 240 to actuate toward the brake rotor 125.

Any of the processes illustrated using the second set of shapes (shown in FIG. 2) may be performed, in part or whole, by digital processors (e.g., central processors, processor cores, etc.) that execute corresponding instructions (e.g., computer code/software) of controller 700. Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components of the controller 700 such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

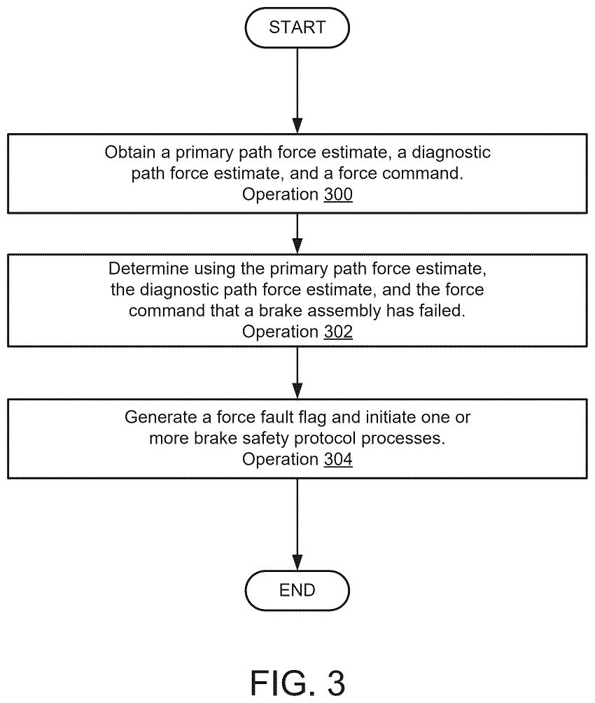

Turning to FIG. 3, a flowchart illustrating a method for force diagnostics in a force-sensor-less brake assembly according to one or more exemplary embodiments of the present disclosure. The operations of the flowchart of FIG. 3 may be performed, for example, by the controller 700 of the brake assembly 10. Although shown as a series of temporal steps, the operations of the flowchart 3 need not be performed in the exact order shown in FIG. 3 and any of the operations can be performed in any order without departing from the scope and spirit of embodiments disclosed herein.

At Operation 300, and as discussed above in reference to FIG. 2 the controller 700 of brake assembly 10 may obtain a primary path force estimate, a diagnostic path force estimate, and a force command. In embodiments, the brake assembly 10 is a force-sensor-less brake assembly that is configured without any force sensors for directly (or indirectly) measuring a braking force (e.g., a clamping force) generated by the brake assembly 10 during braking operations of the vehicle in which the brake assembly 10 is installed.

In embodiments, the primary path force estimate may be obtained using the motor position and the motor torque of electric motor 520. The diagnostic path force estimate may be obtained using a motor linear position, a motor temperature, and a pad wear of the brake assembly 10. The force command 270 may be provided to the controller 700 by a central controller (e.g., a chassis controller or the like) of the vehicle.

In embodiments, a single instance (or multiple instances) of the primary path force estimate, the diagnostic path force estimate, and the force command may be obtained by the controller 700 during each braking operation performed by the vehicle (e.g., in response to braking commands from a driver of the vehicle).

Additional force estimates separate from the primary path force estimate and the diagnostic path force estimate may also be obtained (e.g., calculated) using other measured operating properties of the brake assembly 10 without departing from the scope of embodiments disclosed herein.

At Operation 302, and as discussed above in reference to FIG. 2, the controller 700 may determine using the primary path force estimate, the diagnostic path force estimate, and the force command that the brake assembly has failed.

In embodiments, the brake assembly 10 may have failed as a result of not being able to produce sufficient force (e.g., clamping force, braking force, etc.) during one or more braking operations performed by the vehicle.

At Operation 304, and as discussed above in reference to FIG. 2, the controller 700 may generate (e.g., in response to determining that the brake assembly has failed) a force fault flag and initiate (e.g., using or without using the force fault flag) one or more brake safety protocol processes.

In embodiments, the one or more brake safety protocol processes may be executed in combination with the central controller of the vehicle to ensure that the driver is made aware of the failure of the brake assembly 10.

The method of FIG. 3 may end following Operation 304.

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) system comprising:
a brake rotor configured to be rotatable with a wheel of a vehicle;
a brake pad assembly configured to be engageable with the brake rotor;
an actuator assembly comprising an electric motor configured to mechanically move the brake pad assembly toward or away from the brake rotor; and
an electronic control unit (ECU) comprising a processor associated with a memory that stores instructions that when executed by the processor causes the ECU to perform operations comprising:
obtaining a primary path force estimate, a diagnostic path force estimate, and a force command;
determining whether the EMB system has failed using the primary path force estimate, the diagnostic path force estimate, and the force command; and
generating a force fault flag and initiating one or more brake safety protocol processes in response to failure of the EMB system, wherein the EMB system is a force-sensor-less EMB system that is configured without any force sensors.

2. The EMB system of claim 1, wherein the primary path force estimate is obtained using a motor torque and a motor position of the electric motor.

3. The EMB system of claim 2, wherein the diagnostic path force estimate is obtained using at least one of a motor temperature or a motor linear position of the electric motor.

4. The EMB system of claim 3, wherein the motor torque, the motor position, the motor temperature, and the motor linear position of the electric motor are obtained by the ECU using one or more sensors installed within the EMB system.

5. The EMB system of claim 4, wherein the diagnostic path force estimate is obtained further using a pad wear of brake pads making up the brake pad assembly.

6. The EMB system of claim 5, wherein the determining of whether the EMB system has failed comprises determining whether the EMB system is unable to produce a required amount of braking force during a braking operation of the vehicle.

7. The EMB system of claim 6, wherein the determining of whether the EMB system has failed using the primary path force estimate, the diagnostic path force estimate, and the force command comprises:
incrementing a force error counter each time the ECU determines, using the primary path force estimate, the diagnostic path force estimate, and the force command, that the EMB system is unable to produce the required amount of the braking force during the braking operation of the vehicle; and
determining, in response to the force error counter exceeding a predetermined threshold, that the EMB system has failed.

8. The EMB system of claim 6, wherein the force command is obtained from a central controller of the vehicle that is separate and independent from the ECU, the force command specifying a type of braking operation to be implemented by the EMB system and an amount of braking force to be generated by the EMB system.

9. The EMB system of claim 1, wherein the initiating of one or more brake safety protocol processes comprises causing the EMB system to transition to a safe mode and notifying a central controller of the vehicle of the transition, the central controller being separate and independent from the ECU.

10. The EMB system of claim 1, wherein the primary path force estimate, the diagnostic path force estimate, and the force command are obtained by the ECU during a braking operation of the vehicle.

11. A method configured to be executed by an electronic control unit (ECU) associated with an electromechanical brake (EMB) system, the method comprising:
obtaining a primary path force estimate, a diagnostic path force estimate, and a force command;
determining whether the EMB system has failed using the primary path force estimate, the diagnostic path force estimate, and the force command; and
generating a force fault flag and initiating one or more brake safety protocol processes,
wherein the EMB system is a force-sensor-less EMB system that is configured without any force sensors, and
wherein the EMB system comprises a brake rotor configured to be rotatable with a wheel of a vehicle on which the EMB system is installed, a brake pad assembly configured to be engageable with the brake rotor, and an actuator assembly comprising an electric motor configured to mechanically move the brake pad assembly toward or away from the brake rotor.

12. The method of claim 11, wherein the primary path force estimate is obtained using a motor torque and a motor position of the electric motor.

13. The method of claim 12, wherein the diagnostic path force estimate is obtained using at least one of a motor temperature or a motor linear position of the electric motor.

14. The method of claim 13, wherein the motor torque, the motor position, the motor temperature, and the motor linear position of the electric motor are obtained by the ECU using one or more sensors installed within the EMB system.

15. The method of claim 14, wherein the diagnostic path force estimate is obtained further using a pad wear of brake pads making up the brake pad assembly.

16. The method of claim 15, wherein the determining of whether the EMB system has failed comprises determining whether the EMB system is unable to produce a required amount of braking force during a braking operation of the vehicle.

17. The method of claim 16, wherein the determining of whether the EMB system has failed using the primary path force estimate, the diagnostic path force estimate, and the force command comprises:
incrementing a force error counter each time the ECU determines, using the primary path force estimate, the diagnostic path force estimate, and the force command, that the EMB system is unable to produce the required amount of the braking force during the braking operation of the vehicle; and
determining, in response to the force error counter exceeding a predetermined threshold, that the EMB system has failed.

18. The method of claim 16, wherein the force command is obtained from a central controller of the vehicle that is separate and independent from the ECU, the force command specifying a type of braking operation to be implemented by the EMB system and an amount of braking force to be generated by the EMB system.

19. The method of claim 11, wherein the initiating of one or more brake safety protocol processes comprises causing the EMB system to transition to a safe mode and notifying a central controller of the vehicle of the transition, the central controller being separate and independent from the ECU.

20. The method of claim 11, wherein the primary path force estimate, the diagnostic path force estimate, and the force command are obtained by the ECU during a braking operation of the vehicle.
